(19) United States
(12) Patent Application Publication
(10) Pub. No.: US 2026/0284766 A1
(43) Pub. Date: Sep. 24, 2026

(54) AIR FILTRATION ASSEMBLY WITH POSITIONING AID

(71) Applicant: Apex Brands, Inc., Apex, NC (US)

(72) Inventor: Maciel Jesus Mejia BARRAZA, Queretaro (MX)

(21) Appl. No.: 19/489,313

(22) PCT Filed: Apr. 30, 2024
(86) PCT No.: PCT/US2024/026956

§ 371 Date: Dec. 2, 2025

Related U.S. Application Data
(60) Provisional application No. 63/472,848, filed on Jun. 14, 2023.

(51) Int. Cl. B23K 3/02; B01D 46/46

(52) U.S. Cl. CPC B23K 3/029; B01D 46/46; B01D 2201/28

(57) ABSTRACT

An air filtration assembly for filtering gas or particles generated responsive to operation of a work tool may include an intake which may be repositionable relative to the work tool, a housing which may be operably coupled to the intake and may include a filter, a motor and processing circuitry and an exhaust operably coupled to the housing. The processing circuitry may control the operation of both the air filtration assembly and the work tool. Air may enter the air filtration assembly at the intake responsive to operation of the motor, before passing through the filter and exiting out the exhaust. The intake may include an optical positioning aid assembly to guide a user relative to positioning the intake relative to the work tool to optimize efficiency of the air filtration assembly.

### TECHNICAL FIELD

Example embodiments generally relate to air filtration assemblies and, in particular, relate to such assemblies having performance assurance measures.

### BACKGROUND

Many tasks or processes that may commonly take place in manufacturing or lab settings may generate unwanted byproducts in various forms. For example, processes involving certain materials and chemicals may create waste that may need to be dealt with appropriately either via proper disposal or cleaning. In some cases, the byproducts may be airborne and may require the use of an air filtration assembly to dispose of them accordingly. One such task that may generate airborne byproducts may be soldering. Soldering tools, which are sometimes referred to as soldering irons or soldering guns, are commonly used in electronics manufacturing and repair activities along with other crafts and industries that involve metalwork. Soldering tools are typically used to join metallic items together at a joint by melting a filler metal (i.e., solder) into the joint. A tip portion of the soldering tool may, due to operation of a heater, become hot enough to melt solder that contacts the tip portion. The act of melting the solder, and thus soldering in general, may release gas into the air that may contain volatile organic compounds (VOC's) or other chemicals.

Soldering and other related tasks may often be performed at a workstation indoors. In some cases, the workstation may be located near other workstations and sometimes within the same room. Thus, an air filtration assembly may be employed to filter the air around the workstation where the task may be taking place. Common considerations to make regarding the configuration and use of the air filtration assembly may include ensuring it is adequately sized for the space it is occupying, ensuring it is operating effectively, and improving its overall ease of operation/user experience. Thus, it may be desirable to provide an improved air filtration assembly to address some of the above considerations to create an environment that may be safer for the user and other potential surrounding workstations.

### BRIEF SUMMARY OF SOME EXAMPLES

In an example embodiment, an air filtration assembly for filtering gas or particles generated responsive to operation of a work tool may be provided. The air filtration assembly may include an intake which may be repositionable relative to the work tool, a housing which may be operably coupled to the intake and may include a filter, a motor and processing circuitry and an exhaust operably coupled to the housing. The processing circuitry may control the operation of both the air filtration assembly and the work tool. Air may enter the air filtration assembly at the intake responsive to operation of the motor, before passing through the filter and exiting out the exhaust. The intake may include an optical positioning aid assembly to guide a user relative to positioning the intake relative to the work tool to optimize efficiency of the air filtration assembly.

In another example embodiment, an optical positioning aid assembly to guide a user relative to positioning an intake of the air filtration assembly relative to a work tool to optimize efficiency of the air filtration assembly for filtering gas or particles generated responsive to operation of the work tool may be provided. The optical positioning aid assembly may include a first light disposed at the intake, a second light disposed at the intake offset from the first light, a third light disposed at the intake offset from the first and second lights and forming a triangle with the first and second lights, and a fourth light disposed on a downward facing side of the intake. Each of the first, second, third and fourth lights may be aimed at a work surface on which the work tool may be disposed.

In another example embodiment, a work system may be provided. The work system may include a work tool, a workstation at which the work tool may perform a work task, and an air filtration assembly for filtering gas or particles generated responsive to operation of the work tool. The air filtration assembly may include an intake which may be repositionable relative to the work tool, a housing which may be operably coupled to the intake and may include a filter, a motor and processing circuitry and an exhaust operably coupled to the housing. The processing circuitry may control the operation of both the air filtration assembly and the work tool. Air may enter the air filtration assembly at the intake responsive to operation of the motor, before passing through the filter and exiting out the exhaust. The intake may include an optical positioning aid assembly to guide a user relative to positioning the intake relative to the work tool to optimize efficiency of the air filtration assembly.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of an air filtration assembly according to an example embodiment;

FIG. 2 illustrates a perspective view of the air filtration assembly of FIG. 1 in accordance with an example embodiment;

FIG. 3 illustrates a perspective view of the air filtration assembly of FIG. 1 in accordance with an example embodiment;

FIG. 4 illustrates a perspective view of the air filtration assembly of FIG. 1 in accordance with an example embodiment; and

FIG. 5 illustrates a perspective view of the air filtration assembly of FIG. 1 in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of an air filtration assembly that includes features that improve its operation. In some cases, an optical positioning aid assembly may be employed to ensure the air filtration assembly is efficiently positioned to filter the air from a particular work task. A user of the air filtration assembly may utilize the optical positioning aid assembly to ensure the intake of the air filtration assembly is in a correct position. However, other strategies and features are also contemplated as described in greater detail below.

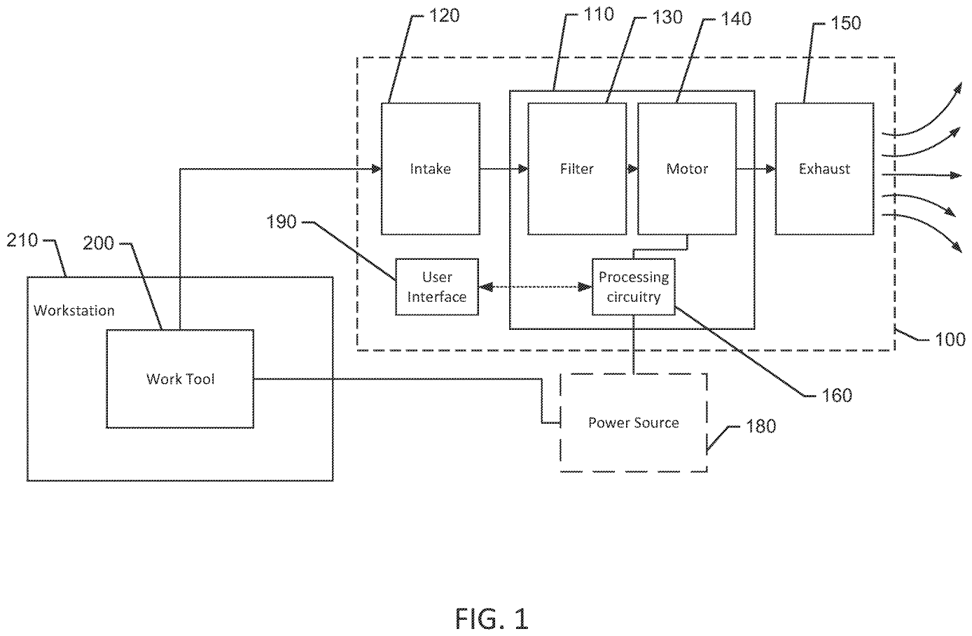

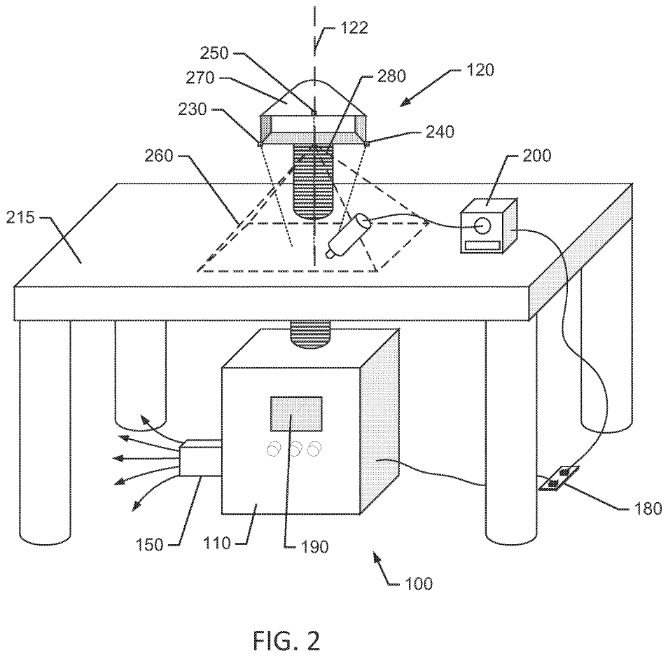

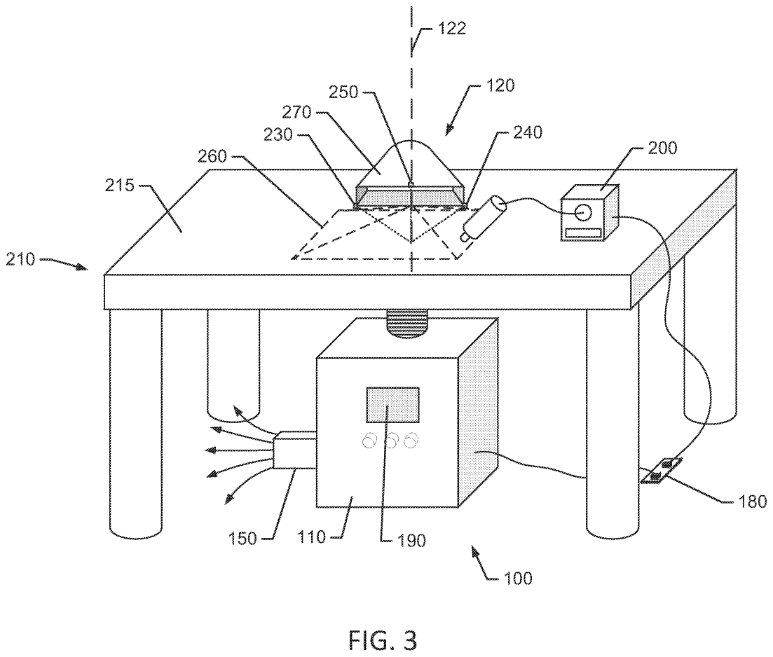

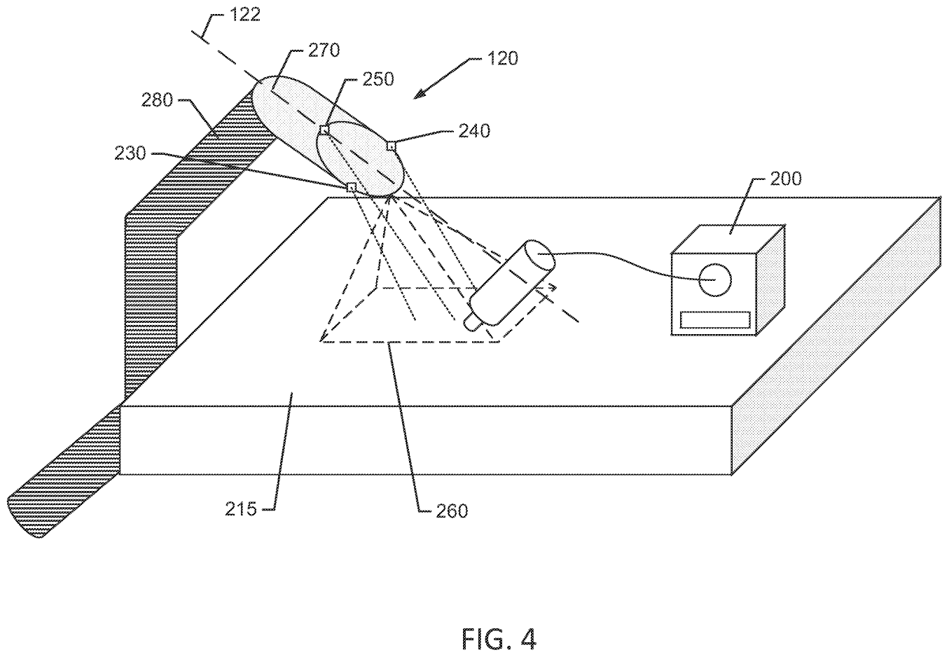

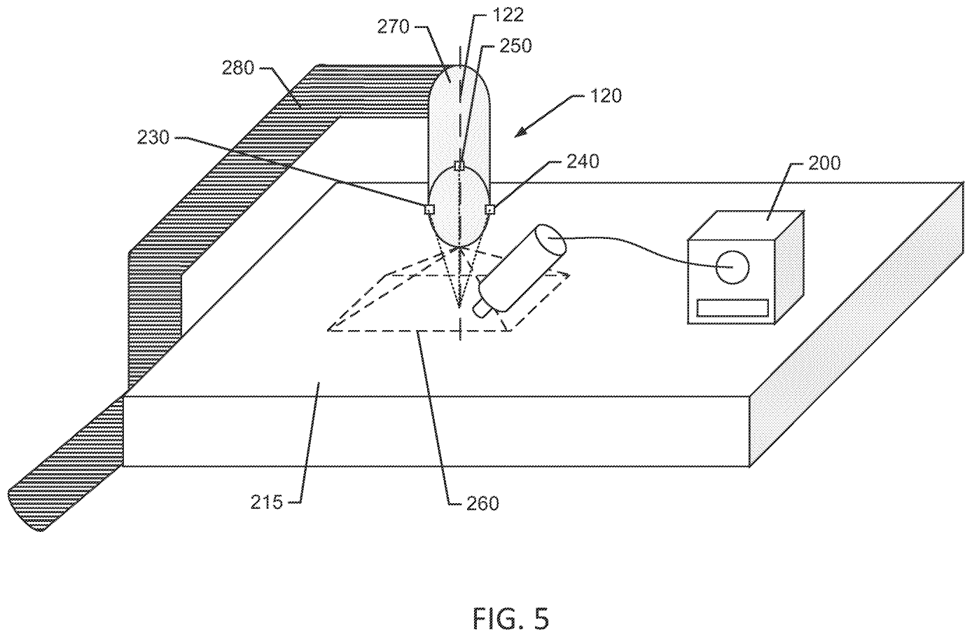

FIG. 1 illustrates a block diagram of an air filtration assembly 100 according to an example embodiment. FIG. 2 illustrates a perspective view of the air filtration assembly 100 set up at a workstation 210 in accordance with an example embodiment. FIG. 3 illustrates a perspective view of the air filtration assembly 100 set up at a workstation 210 and efficiently positioned above a work surface 215 in accordance with an example embodiment. FIG. 4 illustrates a close up perspective view of the air filtration assembly 100 set up at a workstation 210 in accordance with an example embodiment. FIG. 5 illustrates a close up perspective view of the air filtration assembly 100 set up at a workstation 210 and efficiently positioned above a work surface 215 in accordance with an example embodiment.

The air filtration assembly 100 of some embodiments may include a housing 110, an intake 120, a filter 130, a motor 140, an exhaust 150 and processing circuitry 160. In some cases, the housing 110 may contain the filter 130, the motor 140 and the processing circuitry 160 within the housing 110. The housing 110 may take on any number of shapes and sizes depending on various design constraints such as the volume of air that the air filtration assembly 100 may need to filter, or in what type of setting the air filtration assembly 100 may be used in. For example, in some cases the air filtration assembly 100 may be a relatively small assembly, and thus the housing 110 may be configured to be disposed on a desktop/workbench. In other cases the air filtration assembly 100 may be slightly larger and thus the housing 110 may be configured to be disposed under a desk/workbench. In another case, the air filtration assembly 100 may be even larger still and configured to be disposed nearby as a standalone assembly. Thus, the housing 110 may take on different shapes and/or sizes depending on the particular needs and configuration of each embodiment dictated by the environment and the particular use case of the air filtration assembly 100.

The housing 110 may also include the intake 120 and the exhaust 150 operably coupled thereto. In this regard, and as shown in FIG. 1, air may enter the air filtration assembly 100 through the intake 120 before proceeding to pass through the filter 130 responsive to the operation of the motor 140 driving a fan or other mechanism to facilitate airflow through the air filtration assembly 100. The air may exit the air filtration assembly 100 through the exhaust 150 where it may then reenter the immediate surrounding environment, or be directed elsewhere, responsive to having any airborne particles filtered out of the air by the filter 130. In some cases, the filter 130 may be a high efficiency particulate air (HEPA) filter. In some other cases, different levels/forms of filtration may be desired which may necessitate different types of filters for larger or smaller airborne particulates, and even some gaseous compounds.

The air filtration assembly 100 may be powered by a power source 180 which, according to an example embodiment, may be a source of electrical energy such as a battery or a connection to mains power. Operation of the air filtration assembly 100 may be controlled by the processing circuitry 160 which may be operably coupled to the power source 180 to control the delivery of power to the motor 140 accordingly. In this regard, the processing circuitry 160 may also be operably coupled to a user interface 190 that, in some cases, may be disposed at the housing 110. The user interface 190 may be operable by a user to change certain operating parameters of the air filtration assembly 100, such as powering on/off the air filtration assembly 100 and changing an operating speed of the motor 140, among others. In some cases, the processing circuitry 160 may control the operation of the air filtration assembly 100 automatically responsive to input from one or more sensors operably coupled to the processing circuitry 160 and without user input from the user interface 190. In another example embodiment, the processing circuitry 160 may operate the air filtration assembly 100 at a set operating speed for specific time intervals responsive to user input at the user interface 190 selecting such a mode of operation.

The processing circuitry 160 may be configured to provide electronic control inputs to one or more functional units of the air filtration assembly 100 and to process data received at or generated by the one or more functional units of the air filtration assembly 100. Thus, the processing circuitry 160 may be configured to perform data processing, control function execution and/or other processing and management services according to an example embodiment. In some embodiments, the processing circuitry 160 may be embodied as a chip or chip set. In other words, the processing circuitry 160 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 160 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 160 may include one or more instances of a processor 162 and memory 164 that may be in communication with or otherwise control other components or modules that interface with the processing circuitry 160. As such, the processing circuitry 160 may be embodied as a circuit chip (e.g., an integrated circuit chip) configured (e.g., with hardware, software or a combination of hardware and software) to perform operations described herein. In some embodiments, the processing circuitry 160 may be embodied as a portion of an onboard computer housed in the housing 110 of the air filtration assembly 100 to control operation of the assembly.

In some other cases, the user interface 190 may not be disposed at the housing 110 and may instead be disposed at a personal electronic device of the user. In this regard, the user may be able to configure the operation of the air filtration assembly 100 wirelessly from a personal electronic device such as a smart phone, a tablet, or a personal computer, any of which may act as the user interface 190 in such embodiments. The user interface 190 may be in communication (i.e. either wirelessly or by wire) with the processing circuitry 160 to receive an indication of a user input at the user interface 190 and/or to provide an audible, visual, tactile or other output to the user. As such, the user interface 190 may include, for example, a display, one or more switches, lights, buttons or keys, speaker, and/or other input/output mechanisms. However, more complex interface mechanisms could be provided in some cases. In some cases, the processing circuitry 160 may control the operating speed of the motor 140 based on input provided to the user interface 190 of the air filtration assembly 100.

FIGS. 1 and 2 also depict a work tool 200 and a workstation 210, which the air filtration assembly 100 may be operably coupled to and/or disposed at. In this regard, the workstation 210 may be a table, desk, workbench or any other sort of structure with a work surface 215 at which a user may perform a work task. In some cases, the workstation 210 may not include a structure at all, and may simply be a general work surface 215 at which the work tool 200 may be disposed. In this regard, the work surface 215 may be the floor or ground in some embodiments. The work tool 200 may be any number of a variety of tools depending on a task that is desired to be accomplished. For example, the work tool 200 may be a soldering tool, a laser cutting tool, a 3D printer, an injection molding tool, a mill, a lathe, a power saw or many other types of tools commonly used in manufacturing and engineering. For the purposes of illustration and explanation of the components and associated structures of the air filtration assembly 100, the work tool 200 shown in FIG. 2 may be a soldering tool.

FIGS. 2-5 depict the air filtration assembly 100 according to different embodiments. As shown in FIGS. 2-5, the intake 120 of the air filtration assembly 100 may include an optical positioning aid assembly 220. Rather than position the intake 120 arbitrarily, or resorting to using the best judgement of the user to position the intake 120, the user may utilize the optical positioning aid assembly 220 to precisely and efficiently position the intake 120 relative to the work surface 215 and the work tool 200 each time the air filtration assembly 100 is used. The optical positioning aid assembly 220 may include a first light 230, a second light 240, a third light 250, and a fourth light 260. The first, second and third lights (230, 240, 250) may be offset from each other in a triangle formation, where the first and second lights (230, 240) may define the base of the triangle and the third light 250 may be disposed at the top of the triangle. The fourth light 260 may be disposed on a downward facing side of the intake 120. In an example embodiment, each of the first, second, third and fourth lights (230, 240, 250, 260) may be lasers, and may be aimed at the work surface 215 on which the work tool 200 is disposed.

In the embodiment of FIGS. 2-5, the first and second lights (230, 240) may be height adjustment lights, and as such, the first and second lights (230, 240) may be angled toward each other. The third light 250 may be an angle adjustment light and it may be aimed parallel to a longitudinal axis 122 of the intake 120. In this regard, the intake 120 of the air filtration assembly 100 may be operably coupled to the work surface 215 in an adjustable manner. Thus, the user of the air filtration assembly 100 may physically grab and move the intake 120 to adjust a the position of the intake 120 for their needs. For instance, the position of the intake may vary depending on the type of task being performed by the work tool 200, as well as the structure of the intake 120 and the airflow permitted by the particular structure of the intake 120. Therefore, the optical positioning aid assembly 220 may be set up differently for different intake 120 structures and/or different work tools 200. In any case, the user of the air filtration assembly 100 may move the intake 120 to a select height above the work surface 215 using the first and second lights (230, 240) as a guide. In this regard, since the first and second lights (230, 240) are angled toward one another, the first and second lights (230, 240) may align and overlap with one another on the work surface 215 responsive to the intake 120 being disposed the select height above the work surface 215.

Once the select height of the intake 120 has been set, the user may then adjust the angle of the intake 120 by pivoting the intake down or up using the third light 250 as a guide. In an example embodiment, when the third light 250 aligns and overlaps with the first and second lights (230, 240) on the work surface 215, the intake 120 may be disposed at a select angle relative to the work surface 215. Thus, with the intake 120 positioned at the select height and select angle relative to the work surface 215 using the optical positioning aid assembly 220, the air filtration assembly 100 may be positioned to operate in a state of peak airflow efficiency to filter the air around the work tool 200. With the optical positioning aid assembly 220, the user may be able to replicate this ideal position for the intake 120 easily and precisely each time the work tool 200 and the air filtration assembly 100 are used.

In some cases, the fourth light 260 may illuminate an area on the work surface 215 within which air flow into the intake 120 is at a maximum. In other words, the fourth light 260 may illuminate an area on the work surface 215, and the work tool 200 should be operated inside this area illuminated by the fourth light 260 in order for the air filtration assembly 100 to be most effective in filtering the air pollutants generated by the work tool 200. In this regard, the user may not only know that the intake 120 is in a position of maximum efficiency, but that the work tool 200 is being used in an ideal position to promote peak operation of the air filtration assembly 100. Thus, in an ideal operating setting, the first, second and third lights (230, 240, 250) may all align and overlap with each other to form a single dot on the work surface 215 within the area illuminated by the fourth light 260, where the work tool 200 is also disposed within the area illuminated by the fourth light 260.

In an example embodiment, the intake 120 may include a nozzle 270 operably coupled to a hose 280. The nozzle 270 may be funnel shaped, as shown in the embodiment depicted in FIGS. 2 and 3, sloped, as depicted in the embodiment of FIGS. 4 and 4, or any other suitable shape of nozzle 270 for optimizing air flow into the intake 120. The funnel shaped nozzle 270 shown in FIGS. 2 and 3 may take in air at an opening disposed at a distal end of the nozzle 270 which may be larger than an operable coupling of the nozzle 270 to the hose 280. As such, the funnel shaped nozzle may funnel air from the opening to the hose 280. The sloped nozzle 270, on the other hand, may include an opening that is angled relative to the longitudinal axis 122 of the intake 120 rather than be disposed normal to the longitudinal axis 122. In some cases, the optical positioning aid assembly 220 is disposed at a distal end of the nozzle 270 and the hose 280. In an example embodiment, the hose 280 may be semi-rigid in that it may be capable of being adjusted by hand, but will otherwise hold its shape and position if left alone. In some cases, the hose 280 may be operably coupled to the work surface 215. The hose 280 may be extendable and/or retractable from its operable coupling with the work surface 215 in some cases. In other cases, the hose 280 may not be extendable or retractable. In an example embodiment, the first, second, third and fourth lights (230, 240, 250, 260) may be lasers. In some other cases, the first, second, third and fourth lights (230, 240, 250, 260) may be spotlights. In an example embodiment, the first, second, third and fourth lights (230, 240, 250, 260) may be individually powered by batteries. In some cases, the first, second, third and fourth lights (230, 240, 250, 260) may be powered by the power source 180 via a wire extending along the hose 280 back to the housing 110. In an example embodiment, the first, second, third and fourth lights (230, 240, 250, 260) may be operable via a switch, either independently or as a group. In some cases, the first, second, third and fourth lights (230, 240, 250, 260) may be operable via the user interface, either independently or as a group.

Some example embodiments may provide for an air filtration assembly for filtering gas or particles generated responsive to operation of a work tool. The air filtration assembly may include an intake which may be repositionable relative to the work tool, a housing which may be operably coupled to the intake and may include a filter, a motor and processing circuitry and an exhaust operably coupled to the housing. The processing circuitry may control the operation of both the air filtration assembly and the work tool. Air may enter the air filtration assembly at the intake responsive to operation of the motor, before passing through the filter and exiting out the exhaust. The intake may include an optical positioning aid assembly to guide a user relative to positioning the intake relative to the work tool to optimize efficiency of the air filtration assembly.

In some cases, the air filtration assembly described above may be augmented or modified by altering individual features mentioned above or adding optional features. The augmentations or modifications may be performed in any combination and in any order. For example, in some cases, the optical positioning aid assembly may include a first light, a second light, a third light and a fourth light. In an example embodiment, each of the first, second, third and fourth lights may be aimed at a work surface on which the work tool may be disposed. In some cases, the first and second lights may be height adjustment lights and the third light may be an angle adjustment light. In an example embodiment, the first and second lights may be angled toward each other and the third light may be aimed parallel to a longitudinal axis of the intake. In some cases, the first and second lights may overlap responsive to the intake being disposed a select height above the work surface. In an example embodiment, the third light may overlap with the first and second lights responsive to the intake being disposed at a select angle relative to the work surface. In some cases, the fourth light may illuminate an area on the work surface from which air flow into the intake may be at a maximum. In an example embodiment, the first, second and third lights may all overlap with each other to form a single light on the work surface within the area illuminated by the fourth light responsive to the intake being positioned at the select height and the select angle relative to the work surface. In some cases, the intake may be a nozzle operably coupled to a hose. In an example embodiment, the optical positioning aid assembly may be disposed at a distal end of the nozzle and the hose. In some cases, the nozzle may be a funnel shaped nozzle. In an example embodiment, the nozzle may be a sloped nozzle. In some cases, the work tool may be a soldering tool. In an example embodiment, the processing circuitry may control an operating speed of the motor based on input into a user interface of the air filtration assembly.

Some example embodiments may provide for an optical positioning aid assembly to guide a user relative to positioning an intake of the air filtration assembly relative to a work tool to optimize efficiency of the air filtration assembly for filtering gas or particles generated responsive to operation of the work tool. The optical positioning aid assembly may include a first light disposed at the intake, a second light disposed at the intake offset from the first light, a third light disposed at the intake offset from the first and second lights and forming a triangle with the first and second lights, and a fourth light disposed on a downward facing side of the intake. Each of the first, second, third and fourth lights may be aimed at a work surface on which the work tool may be disposed.

Some example embodiments may provide for a work system. The work system may include a work tool, a workstation at which the work tool may perform a work task, and an air filtration assembly for filtering gas or particles generated responsive to operation of the work tool. The air filtration assembly may include an intake which may be repositionable relative to the work tool, a housing which may be operably coupled to the intake and may include a filter, a motor and processing circuitry and an exhaust operably coupled to the housing. The processing circuitry may control the operation of both the air filtration assembly and the work tool. Air may enter the air filtration assembly at the intake responsive to operation of the motor, before passing through the filter and exiting out the exhaust. The intake may include an optical positioning aid assembly to guide a user relative to positioning the intake relative to the work tool to optimize efficiency of the air filtration assembly.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. An air filtration assembly for filtering gas or particles generated responsive to operation of a work tool, the air filtration assembly comprising:
an intake repositionable relative to the work tool;
a housing operably coupled to the intake, the housing comprising a filter, a motor and processing circuitry; and
an exhaust operably coupled to the housing,
wherein the processing circuitry is configured to control operation of the air filtration assembly,
wherein air enters the air filtration assembly at the intake responsive to operation of the motor, before passing through the filter and exiting out the exhaust, and
wherein the intake comprises an optical positioning aid assembly to guide a user relative to positioning the intake relative to the work tool to optimize efficiency of the air filtration assembly.

2. The air filtration assembly of claim 1, wherein the optical positioning aid assembly comprises a first light, a second light, a third light and a fourth light, and
wherein each of the first, second, third and fourth lights are aimed at a work surface on which the work tool is disposed.

3. The air filtration assembly of claim 2, wherein the first and second lights are height adjustment lights and the third light is an angle adjustment light.

4. The air filtration assembly of claim 3, wherein the first and second lights are angled toward each other and the third light is aimed parallel to a longitudinal axis of the intake, and
wherein the first and second lights overlap responsive to the intake being disposed a select height above the work surface at which efficiency of the air filtration assembly is optimized.

5. The air filtration assembly of claim 4, wherein the third light overlaps with the first and second lights responsive to the intake being disposed at a select angle relative to the work surface.

6. The air filtration assembly of claim 5, wherein the fourth light illuminates an area on the work surface from which air flow into the intake is at a maximum.

7. The air filtration assembly of claim 6, wherein the first, second and third lights all overlap with each other to form a single light on the work surface within the area illuminated by the fourth light responsive to the intake being positioned at the select height and the select angle relative to the work surface.

8. The air filtration assembly of claim 1, wherein the intake is a nozzle operably coupled to a hose, and
wherein the optical positioning aid assembly is disposed at a distal end of the nozzle and the hose.

9. The air filtration assembly of claim 8, wherein the nozzle is a funnel shaped nozzle.

10. The air filtration assembly of claim 8, wherein the nozzle is a sloped nozzle.

11. The air filtration assembly of claim 1, wherein the work tool is a soldering tool.

12. The air filtration assembly of claim 1, wherein the processing circuitry controls an operating speed of the motor based on input into a user interface of the air filtration assembly.

13. An optical positioning aid assembly to guide a user relative to positioning an intake of the air filtration assembly relative to a work tool to optimize efficiency of the air filtration assembly for filtering gas or particles generated responsive to operation of the work tool, the optical positioning aid assembly comprising:
a first light disposed at the intake;
a second light disposed at the intake and offset from the first light;
a third light disposed at the intake offset from the first and second lights and forming a triangle with the first and second lights; and
a fourth light disposed at the intake,
wherein each of the first, second, third and fourth lights are aimed at a work surface on which the work tool is disposed.

14. The optical positioning aid assembly of claim 13, wherein the first and second lights are height adjustment lights angled toward each other and the third light is an angle adjustment light and aimed parallel to a longitudinal axis of the intake, and
wherein the first and second lights overlap responsive to the intake being disposed a select height above the work surface at which efficiency of the air filtration assembly is optimized.

15. The optical positioning aid assembly of claim 14, wherein the third light overlaps with the first and second lights responsive to the intake being disposed at a select angle relative to the work surface.

16. The optical positioning aid assembly of claim 15, wherein the fourth light illuminates an area on the work surface within which air flow into the intake is at a maximum.

17. The optical positioning aid assembly of claim 16, wherein the first, second and third lights all overlap with each other to form a single light on the work surface within the area illuminated by the fourth light responsive to the intake being positioned at the select height and the select angle relative to the work surface.

18. The optical positioning aid assembly of claim 13, wherein the intake is a nozzle operably coupled to a hose, and
wherein the optical positioning aid assembly is disposed at a distal end of the nozzle and the hose.

19. The optical positioning aid assembly of claim 18, wherein the nozzle is a funnel shaped nozzle.

20. A work system comprising:
a work tool;
a workstation at which the work tool performs a work task; and
an air filtration assembly for filtering gas or particles generated responsive to operation of the work tool, the air filtration assembly comprising:
an intake repositionable relative to the work tool;
a housing operably coupled to the intake, the housing comprising a filter, a motor and processing circuitry; and
an exhaust operably coupled to the housing,
wherein the processing circuitry is configured to control operation of the air filtration assembly,
wherein air enters the air filtration assembly at the intake responsive to operation of the motor, before passing through the filter and exiting out the exhaust, and
wherein the intake comprises an optical positioning aid assembly to guide a user relative to positioning the intake relative to the work tool to optimize efficiency of the air filtration assembly.
